(19) United States
(12) Patent Application Publication
(10) Pub. No.: US 2001/0034955 A1
(43) Pub. Date: Nov. 1, 2001

(54) Relaxation dryer

(75) Inventor: Roland Hampel, Ubach-Palenberg (DE)

Correspondence Address: COLLARD & ROE, P.C., 1077 Northern Boulevard, Roslyn, NY, 11576, US

(73) Assignee: A. Monforts Textilmaschinen GmbH & Co.

(21) Appl. No.: 09/833,508

(22) Filed: Apr. 12, 2001

(30) Foreign Application Priority Data
Apr. 26, 2000 (DE) 100 20 387.6

(51) Int. Cl. F26B 11/02

(52) U.S. Cl. 34/114

(57) ABSTRACT

A relaxation dryer for the stress-free drying and simultaneous relaxing shrinking of a web of textile material. The material web is guided along a sinusoidal course in the relaxation channel between two air-permeable transport belts by alternately blowing the web from the top and from the bottom. In order to exert on the web an additional tumble effect, the sinusoidal curve of the web is disturbed at preset intervals by air-impermeable strips provided in one and/or the other transport belt.

### BACKGROUND OF THE INVENTION

1. Field of the Invention

The invention relates to a relaxation dryer for the stressless drying and simultaneous relaxing shrinking of a spread textile web consisting of woven or knitted or fleece material. The drying takes place along a sinusoidal course in a relaxation channel between two air-permeable transport belts, specifically between a support belt and a counterholding belt. The material web is advanced in the course of the operation together with the transport belts in the longitudinal direction of the web. Rows of spatially fixed blowing nozzles extending transversely to the longitudinal direction of the web are associated with the material web outside of the relaxation channel. Viewed in the longitudinal direction of the web, the nozzles blow air in an alternating manner against the support belt and the counterholding belt (see, for example DE 29 42 030 A1).

In the relaxation dryer, the material web is transported through the relaxation or treatment channel, which is limited and defined by the transport belts. The transporting direction, which is the longitudinal direction of the web, and the longitudinal direction of the channel are therefore the same. Although a transporting effect is exerted on the material web only by the support belt, both belts are referred as transport belts within the frame work of the present specification for the sake of simplicity. Furthermore, the belts may interchange their supporting/counterholding functions in conjunction with a two- or multi-shelf dryer, which falls within the scope of the invention as well.

2. The Prior Art

Machines of the type specified above are manufactured and sold under the trade name “DynAir”. The relaxation dryer that has become known in this way is employed for woven and knitted materials. The material is charged in the form of an open web or a hose. The relaxation dryer is suitable also as a pre-dryer in combination with other finishing machines. It may be arranged downstream of a padding machine and combined with a stretching frame downstream, on which the material web is stretched wide and, for example set.

It is possible in various pretreatment processes to generate different transverse and longitudinal stresses or expansions in the respective material web. Such asymmetries can be largely eliminated with the help of the known relaxation dryer because as the rows of nozzles oppose each other in an offset way at the top and bottom, the material web is constantly moved back and forth perpendicular to its plane of transport as it is passing through the dryer. This uniformly alternating movement of the material web in approximately sinusoidal, spatially standing waves results in a relaxing shrinking of the material web.

One feature of the known relaxation dryer is the approximately sinusoidal passage of the material web in the form of a spatially standing wave through the relaxation channel between the two transport belts. In a dryer in which the material web is guided horizontally, nozzles are arranged underneath the lower transport belt, which is the support belt, and on top of the upper belt, which is the counterholding belt. Viewed in the direction in which the web is running, the nozzles are directed at the material web trapped in the relaxation channel between the transport belt in an alternating manner, from below and from the top. These rows of nozzles are generally made up of perforated nozzles. The rows of nozzles are arranged transversely in relation to the longitudinal direction of the web, or direction of transport. An upper row of nozzles is preferably provided between two lower rows of nozzles, and vice versa, so that the web is blown in the longitudinal direction alternately from its two surfaces.

What is achieved by blowing the material web alternately from rows of upper and rows of lower nozzles—all nozzles are stationary—is that the web of material moves in the form of the standing, approximately sinusoidal wave. The terms “lower” and “upper” are used only for the sake of simplicity; the relaxation channel may in fact have a horizontal, vertical or slanted course and also reversals from the one treatment stage to the next, for example as in conjunction with so-called rack-type or tiered frames. The same applies in the case of the present invention.

The transport belts are made of teflonized glass fiber fabric. The fabric should not impair the material web, have thermal stability within the range of the intended treatment temperatures, and, if guided over smooth rolls, be controllable in a simple manner. Furthermore, the fabric should be capable of being tensioned in the longitudinal direction.

The relative speed or synchronous run of the transport belts should be adjustable.

### SUMMARY OF THE INVENTION

It is an object of the invention to exert a tumble effect on the material web in addition to effecting relaxation drying. The tumble effect should be producible without requiring substantial reconstruction work on the relaxation plant.

For a relaxation dryer of the type specified above, the invention comprises a relaxtion dryer in which the support belt and/or the counterholding belt have strips extending crosswise in relation to the longitudinal direction of the web. These strips, which are called tumble strips, are impermeable to air, and each momentarily screen off at least one of the rows of nozzles extending transversely to the longitudinal direction of the web, either partially or totally. The effect of the tumble strips as defined by the invention is intended to exert rhythmic air pulses on the material web to achieve a tumble effect that is increased beyond the effect of the relaxation drying.

The tumble strips, even though referred as being impermeable to air, must not be absolutely impermeable to air. However, they should at least put up a notably greater resistance to the air coming from the blow nozzles than the respective transport belt itself. The specification “screen off partially or totally” may relate to both the geometry and the permeability to air of the tumble strip. The tumble strip may be referred to also as the tumble screen because of its screening-off effect. With the help of the tumble strip, it is possible to partially or totally screen off the blowing effect of rows of nozzles or of individual nozzles of each row both in the longitudinal direction of the web and transversely in relation to the web (as the tumble strip passes the nozzle or row of nozzles).

The tumble strips as defined by the invention may be provided on both sides of the relaxation channel, specifically on both transport belts. Alternatively, the strips may be provided only on one side of the relaxation channel, i.e. only on one of the transport belts, thus on the support belt or on the counterholding belt. If the web is guided horizontally, this means that the tumble strips can be arranged above and/or below the path along which the web is traveling.

When one of the air-impermeable tumble strips carried along with the transport belts in the relaxation channel passes in front of one of the rows of nozzles, the air current acting on the material web is always momentarily cancelled, so that the sinusoidal pattern of the standing wave is disturbed at that moment and a tumble pulse is thus impacted on the material web. The tumble strips generating the tumble pulse are jointly moved with the associated transport belt. The tumble effect therefore requires no additional moving or controlled parts. It is simply generated by the movement of the transport belts.

The tumble strips may be arranged on or in the transport belts with a smaller or greater spacing depending on how strong the disturbance or tumble effect is expected to be. The minimum spacing between two air-impermeable strips of a transport belt preferably comes to about one wavelength, and preferably to about two wavelengths based on the sinusoidal pattern of the material web. By removing or attaching more or less wide and/or more or less air-permeable screening strips of the specified type with a greater or lesser spacing, it is possible to vary the tumble effect between zero and a maximum.

The tumble strips may be components of the transport belt, for example integrated by weaving the belt accordingly, or they may be attached to the associated transport belt externally, and also may be removable again, if need be. Externally applicable strips are, for example adhesive strips capable of withstanding the stress in the relaxation channel, in particular adhesive strips that are insensitive to heat. Such adhesive strips are applied to one or more transport belts in such a way that they are pressed against the individual belt by the air current. This means that the adhesive strip is applied to the external side of the channel, specifically to the underside of the support belt, or to the top side of the counterholding belt.

The intensity and action of the tumble effect can be adapted to the given requirements by selecting the width of the strip measured in the longitudinal direction of the web. The duration of the interference can be determined by presetting the width of the strip. The width of the strips may be such that two (or more) nozzles or rows of nozzles following each other in the longitudinal direction of the web are momentarily screened off against the interior of the channel.

Using relatively wide strips may be of particular interest if the screened-off nozzle jets of air are focused on a joint area of action in the relaxation channel. In this case, a distinction can be made between three phases of disturbance. First, an initiating tumble effect occurs when the first nozzle/row of nozzles is screened off. Then follows the phase with the main tumble effect, in which the two nozzles/rows of nozzles are screened off simultaneously (momentarily). At the end, then comes a final phase of the tumble effect, in which the second nozzle/row of nozzles of the pair here under discussion is screened off against the interior of the channel.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a relaxation channel with relatively narrow tumble strips; and

FIG. 2 shows a relaxation channel with relatively wide tumble strips as compared to FIG. 1.

### DETAILED DESCRIPTION OF THE PREFERRED EMBODIMENT

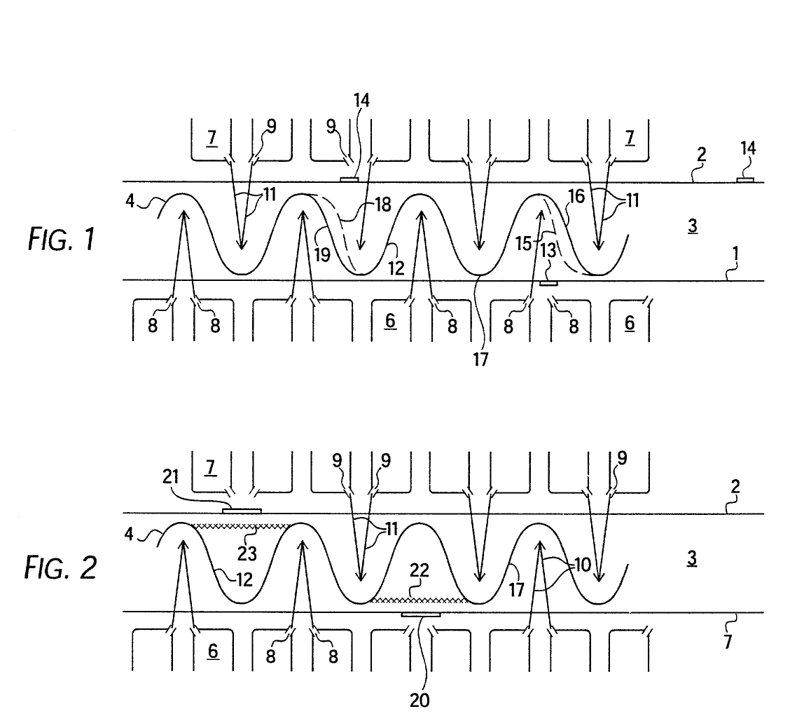

Referring now in detail to the drawings, FIGS. 1 and 2 show a vertical section through a relaxation channel 3, which is formed between the two transport belts 1 and 2 (support belt 1 and counterholding belt 2). Together with the transport belts 1 and 2, a textile material web 4 is advanced in the relaxation channel 3 in its longitudinal direction 5 between the blow or nozzles boxes 6, 7 in the relaxation channel. Each nozzle box 6 and 7 has at least one row of nozzles 8 and 9, respectively, extending transversely in relation to the longitudinal direction 5, with their nozzles being aimed at the relaxation channel 3.

The nozzle boxes 6 and 7 are supplied with compressed air via feed lines (not shown), so that they emit the air jets 10 and, respectively, 11 through the respective air-permeable transport belt 1, 2 and onto the material web 4 via their nozzles 8, 9, which preferably are perforated nozzles. The air jets 10, 11 of two nozzle or blow boxes 6, 7 disposed adjacent to each other on one side of the material web, cooperate with respect to the material web 4 if they are directed inclined against each other, as shown in the drawing. The nozzles are preferably arranged and supplied in such a way that the material web 4, viewed in the longitudinal direction 5, is alternately blown from the top and from the bottom. Such a nozzle arrangement produces, as shown in FIGS. 1 and 2, an approximately sinusoidal, standing wave of the material web 4 as the latter advances in the longitudinal direction 5.

According to the invention, one tumble strip 13 or 14 is associated with at least one nozzle or row of nozzles 8 and/or 9. When such a tumble strip 13, 14 screens off the exiting jets of a row of nozzles 8 or 9 in such a way that the associated jet of air 10 or 11 cannot or cannot completely (in the original direction) enter the relaxation channel 3, this will result in a disturbance of the sinusoidal shape of the wave-like propagation of the material web 4. When an air jet 10 is canceled, the effect of an air jet 11 entering the relaxation channel 3 from the opposite side and impacting the material web 4 relatively increases. This then creates a shift 15 of a half-wave 16 (shown in FIG. 1 by a dashed line) of the sinusoidal curve 17 of the material web that would appear without the strip 13. The conditions are quite similar when a tumble strip 14 of an upper nozzle or row of nozzles 9 screens off or deflects one of the air jets 11. In this case, the relative effect of an air jet 10 impacting from the opposite side of the channel increases, so that the result is a bend or shift 18 of a half-wave 19 of the sinusoidal curve 17 accordingly.

According to FIG. 2, provision is made for the tumble strips 20, 21, which, viewed in the longitudinal direction 5 of the web, are adequately wide for momentarily screening off both jets of the cooperating nozzle pairs 8, 9 simultaneously. The two phases (occurring upon arrival and upon departure of a strip intersecting a nozzle jet) described with the help of FIG. 1 may then occur as well. However, the moment at which both jets of a pair of jets are screened off at the same time is important, because instead of a half-wave of the sinusoidal curve 17, a curled flattening 22 and, respectively, 23 with a multitude of small waves or folds disposed close to each other may then occur.

The asymmetries created according to the invention by the tumble strips, i.e. the half-wave shifts 15, 18, or the flattenings 22, 23, are not stable in terms of time but always and only present when a tumble strip quasi generating such asymmetries momentarily screens off one of the air jets 10 and 11, respectively. Therefore, the asymmetries 15, 18, 22, 23 always appear when a tumble strip screens off a (spatially fixed) nozzle jet. By alternately screening and releasing the individual nozzles or rows of nozzles, the material web 4 is subjected to a rhythmic sequence of air pulses above and underneath the nozzle, which creates the violent movement of the material web required for achieving the tumble effect.

Accordingly, while only a few embodiments of the present invention have been shown and described, it is obvious that many changes and modifications may be made thereunto without departing from the spirit and scope of the invention.

What is claimed is:

1. A relaxation dryer for the stress-free drying and simultaneous shrinking of a spread textile material web consisting of woven or knitted or fleece material and having a longitudinal direction, comprising:
two air-impermeable transport belts comprising a support belt and a counterholding belt, between which a relaxation channel having an approximately sinusoidal path is created for the web to travel, wherein the material web together with the transport belts is advanced in the longitudinal direction of the material web;
a plurality of spatially fixed blow nozzles arranged outside of the relaxation channel in rows extending crosswise in relation to the longitudinal direction of the web, such that the material web, viewed in the longitudinal direction, is alternately blown against the support belt and against the counterholding belt along lines extending approximately transversely to the longitudinal direction of the web,
wherein at least one of the transport belts have zones impermeable to air, said zones each momentarily at least partially screening off at least one of the nozzles against the material web.

2. The relaxation dryer according to claim 1, wherein the air-permeable zones comprise air-impermeable strips extending crosswise in relation to the longitudinal direction of the web, said strips each momentarily at least partially screening off at least one of the nozzle rows extending crosswise in relation to the longitudinal direction of the web against the material web.

3. The relaxation dryer according to claim 2, wherein the mutual spacing of the air-impermeable strips on the same transport belt measured in the longitudinal direction of the web amounts to at least one wavelength, based on the sinusoidal path in which the web is guided.

4. The relaxation dryer according to claim 2, wherein the air-impermeable strips of the associated transport belt are formed by adhesive strips applied to an external side of the channel, to either an underside of the support belt or a top side of the counterholding belt.

5. The relaxation dryer according to claim 2, wherein the air-impermeable strips are integrated in the transport belt.

6. A method for operating a relaxation dryer for the stress-free drying and simultaneous shrinking of a spread textile material web consisting of woven or knitted or fleece material and having a longitudinal direction, using a relaxation dryer having two air-impermeable transport belts comprising a support belt and a counterholding belt, between which a relaxation channel having an approximately sinusoidal path is created for the web to travel, wherein the material web together with the transport belts is advanced in the longitudinal direction of the material web, and a plurality of spatially fixed blow nozzles arranged outside of the relaxation channel in rows extending crosswise in relation to the longitudinal direction of the web, such that the material web, viewed in the longitudinal direction, is alternately blown against the support belt and against the counterholding belt along lines extending approximately transversely to the longitudinal direction of the web, wherein at least one of the transport belts have zones impermeable to air, said zones each momentarily at least partially screening off at least one of the nozzles against the material web, said method comprising:
exerting rhythmic air pulses onto the material web via said nozzles to achieve a tumble effect increased beyond an effect of relaxation treatment.
